(19) United States
(12) Patent Application Publication
(10) Pub. No.: US 2019/0293847 A1
(43) Pub. Date: Sep. 26, 2019

(54) Color Filter Substrate, Manufacturing Method Therefor, and Display Device

(71) Applicants: Hefei BOE Optoelectronics Technology Co., Ltd., Hefei (CN); BOE Technology Group Co., Ltd., Beijing (CN)

(72) Inventors: Kui Gong, Beijing (CN); Xianxue Duan, Beijing (CN)

(73) Assignees: Hefei BOE Optoelectronics Technology Co., Ltd., Hefei (CN); BOE Technology Group Co., Ltd., Beijing (CN)

(21) Appl. No.: 16/318,927

(22) PCT Filed: May 21, 2018
(86) PCT No.: PCT/CN2018/087655

§ 371 Date: Jan. 18, 2019

(30) Foreign Application Priority Data
May 26, 2017 (CN) 201710385683.0

(51) Int. Cl. G02B 5/20; G02F 1/1362; G02F 1/1339

(52) U.S. Cl. CPC G02B 5/201; G02F 1/136204; G02F 2202/22; G02F 2001/136222; G02F 1/1339

(57) ABSTRACT

A color filter substrate, a manufacturing method therefor, and a display device. The color filter substrate includes a base substrate, a conductive layer located on the base substrate; and a color photoresist located on one side of the conductive layer distant from the base substrate. The color resist is electrically conductive and is electrically connected to the conductive layer.

The present application claims priority of China Patent application No. 201710385683.0 filed on May 26, 2017, the content of which is incorporated in its entirety as portion of the present application by reference herein.

### TECHNICAL FIELD

At least one embodiment of the present disclosure relates to a color filter substrate, a manufacturing method therefor, and a display device.

### BACKGROUND

Liquid crystal display device generates static electricity accumulated on a color filter substrate during fabrication and use. Upon the static electricity accumulating to a certain extent, an electrostatic field is generated, which may interfere with an electric field of liquid crystal molecules in the liquid crystal display panel, thereby causing abnormal images. Therefore, it is important for the display device to shield or eliminate external static electricity.

### SUMMARY

At least one embodiment of present disclosure provides a color filter substrate, including: a base substrate; a conductive layer on the base substrate; and a color photoresist on a side of the conductive layer away from the base substrate. The color photoresist is electrically conductive and electrically connected with the conductive layer.

In some examples, the color photoresist is in direct contact with the conductive layer.

In some examples, the color filter substrate further includes a conductive black matrix on the side of the conductive layer away from the base substrate, wherein the conductive layer is in direct contact with the conductive layer.

In some examples, a portion of the conductive layer is exposed by the black matrix and the color photoresist.

In some examples, the conductive layer is a graphene layer or an indium tin oxide film.

In some examples, the conductive layer has a thickness of 1˜10 nm.

In some examples, a material of the black matrix is a metal material or a resin material doped with nano conductive particles.

In some examples, a material of the color photoresist is a resin material doped with nano conductive particles.

In some examples, the resin material includes film-forming resin, photosensitizer, solvent and additive.

In some examples, a resistivity of the conductive particles is less than 1×10⁻⁷ Ω·m.

In some examples, the conductive layer is transparent.

In some examples, the conductive layer is configured to be grounded.

Another embodiment of the present disclosure provides a display device, including the color filter substrate as mentioned above, and a counter substrate. The color filter substrate is opposite to the counter substrate.

In some examples, the display device further includes: a sealant between the color filter substrate and the counter substrate. The sealant is provided with a conductive member therein, an end of the conductive member is electrically connected to the conductive layer of the color filter substrate, and another end of the conductive member is electrically connected to a zero potential line on the counter substrate.

Another embodiment of the present disclosure provides a manufacturing method of a color filter substrate, including: forming a conductive layer on a base substrate; and forming a color photoresist on the conductive layer. The color photoresist is electrically conductive and electrically connected with the conductive layer.

Thus, the antistatic capacity of the display device is improved.

### BRIEF DESCRIPTION OF THE DRAWINGS

In order to clearly illustrate the technical solution of embodiments of the present disclosure, the drawings of the embodiments will be briefly described in the following, it is obvious that the drawings in the description are only related to some embodiments of the present disclosure and not limited to the present disclosure.

FIG. 1 is a structural schematic view of a color filter substrate provided by an embodiment of the present disclosure;

FIG. 2 is a structural schematic view of a display device provided by an embodiment of the present disclosure;

FIG. 3 is a flow chat of a manufacturing method of a color filter substrate provided by an embodiment of the present disclosure;

FIG. 4 is a structural schematic view of the color filter substrate after step 100 is completed in FIG. 3.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

There are two ways to eliminate influence of external static electricity on a liquid crystal display device. The first one: sources of static electricity are reduced or isolated; the method cannot completely solve the problem of static electricity accumulation. The second one: static electricity can be discharged in time by designing a circuit, thereby completely eliminating static electricity. For example, an antistatic layer is disposed on an outer surface of the color filter substrate, and the antistatic layer is connected with a ground end of an array substrate by coating conductive silver glue to achieve an antistatic effect.

For example, a conductive layer or a conductive line can be designed at bottom or top of the black matrix (BM) to completely discharge static electricity on the entire color filter substrate. However, a phenomenon of abnormal images cannot be completely eliminated by only discharging static electricity on BM. Because RGB color photoresist on the color filter substrate is generally insulated, and an external influence can also easily lead to formation of charged ions at a coupling on the RGB color photoresist and accumulation of the charged ions on a surface of the RGB color photoresist. The charged ions cannot be quickly discharged from the RBG color photoresist, which can affect the display device.

FIG. 1 illustrates a structural schematic view of a color filter substrate provided by an embodiment of the present disclosure. The color filter substrate includes a base substrate 1, a conductive layer 2, a black matrix 3, and a color photoresist 4. The color photoresist is an RGB photoresist. As illustrated in FIG. 1, the conductive layer 2 is located above the base substrate 1; the black matrix 3 and the color photoresist 4 are located above the conductive layer 2. Both the black matrix 3 and the color photoresist 4 have electrical conductivity, and the black matrix 3 and the color photoresist 4 partially cover the conductive layer 2.

For example, the conductive layer 2 is transparent.

Optionally, the abovementioned conductive layer 2 can be a graphene layer or an indium tin oxide (ITO) film with a thickness of 1˜10 nm. On the basis of ensuring the conductivity, the thinner the layer, the better. The graphene has good electrical conductivity, with a resistivity of 110⁻⁸ Ω·m, which is less than that of copper and silver. And, the transparency of the graphene is good; a transmittance of a single or multi-layer graphene layer is extremely high. Therefore, graphene is selected as the conductive layer in the present embodiment. Certainly, other conductive materials with good transmittance can also be selected for the conductive layer.

In order to make the black matrix 3 have electrical conductivity, the black matrix 3 can be selected from a metal material or a resin material doped with nano conductive particles.

In order to make the color photoresist 4 have electrical conductivity, the color photoresist 4 can adopt a resin material doped with nano conductive particles.

In order to make the abovementioned resin material doped with nano conductive particles have good electrical conductivity and optical transparency, it is required that a dispersion structure of the nano conductive particles in the resin matrix is less than a visible light wavelength range.

The resin material doped with nano conductive particles in the present embodiment can be made of a conductive medium, film-forming resin, photosensitizer, solvent and additive. In order to ensure good electrical conductivity, the resistivity of the conductive medium is less than 1×10⁻⁷ Ω·m. The conductive medium can be conductive metal particles, conductive alloy particles, and novel conductive materials such as graphene. Graphene has many excellent properties, such as ultra-high theoretical specific surface area (2630 m²/g), outstanding thermal conductivity (500 W/m·K), high-strength (130 GPa), high modulus (1060 GPa), and electro mobility (15000 cm2/(V·s)) which is 100 times higher than silicon at room temperature, and conductivity of 7200 S/cm and so on. Furthermore, as described above, graphene has outstanding electrical conductivity and electron conductivity, a conductive polymer material with high conductivity, low cost and permanent conductivity can be obtained by introducing a small amount of graphene into the polymer. Therefore, in the present embodiment, graphene is selected as the conductive medium. Furthermore, the abovementioned film-forming resin is thermoplastic resin, and the photosensitizer is a derivative of aromatic ketone or a derivative of benzoin ether.

Embodiments of the present disclosure include the following advantages: the conductive layer being formed on the base substrate of the color filter substrate, and the black matrix and the color photoresist having conductivity being formed on the conductive layer to facilitate static electricity accumulating on the black matrix and the color photoresist to be quickly discharged to the conductive layer. The black matrix and the color photoresist partially cover the conductive layer, the exposed conductive layer can discharge the static electricity from a display region. For example, a conductive sealant is connected with a zero potential line of an array substrate, and finally the static electricity on the color filter substrate is led to the zero potential line through the conductive layer, so that the static electricity is discharged from the display region, thereby improving the antistatic capability of the display device and ensuring the display quality.

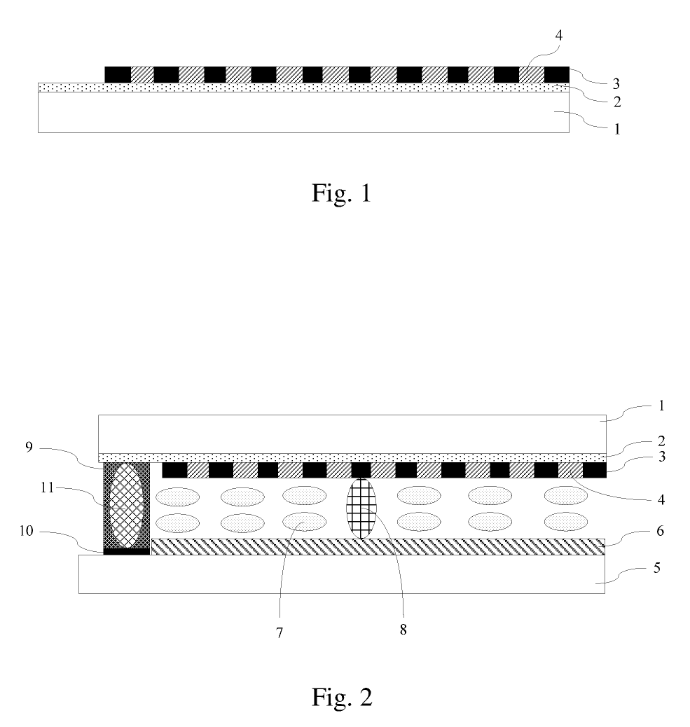

FIG. 2 illustrates a structure view of a display device provided by an embodiment of the present disclosure. The display device includes an array substrate and the abovementioned color filter substrate. The color filter substrate and the array substrate are encapsulated by the sealant 9. The array substrate includes a substrate 5 and a TFT array 6 formed on the substrate 5; the array substrate is further provided with a zero potential line 10; the sealant 9 is provided with a conductive member 11 therein. One end of the conductive member 11 is electrically connected to the exposed conductive layer 2 on the color filter substrate, the other end of the conductive member is electrically connected to the zero potential line 10 on the array substrate; a liquid crystal 7 is further filed between the array substrate and the color filter substrate, and a spacer 8 is provided between the color filter substrate and the array substrate for supporting.

Optionally, the abovementioned conductive member 11 located in the sealant 9 can be a solid metal ball. In order to ensure that the solid metal ball is in tight electrical connection with the conductive layer 2 and the zero potential line 10 at both ends, the original diameter of the solid metal ball is slightly greater than a distance between the color filter substrate and the array substrate. Thus, upon the two substrates being encapsulated by the sealant 9, the solid metal ball is deformed under the pressure of the two substrates, and the tight electrical connection of the solid metal ball with the conductive layer 2 and the zero potential line 10 is realized to prevent the occurrence of poor contact and ensure the reliability of the conduction.

In the structure, the static electricity accumulated on the black matrix 3 and the color photoresist 4 of the color filter substrate can be discharged to the conductive layer 2, and further discharged by the conductive member 11 in the sealant 9 electrically connected with the conductive layer 2 into the zero potential line 10 on the array substrate, finally the static electricity on the color filter substrate is discharged from the display region.

Embodiments of the present disclosure include the following advantages: the conductive layer being formed on the base substrate of the color filter substrate, and the black matrix and the color photoresist having conductivity being formed on the conductive layer to facilitate the static electricity accumulating on the black matrix and the color photoresist to be quickly discharged to the conductive layer. The black matrix and the color photoresist partially cover the conductive layer, the exposed conductive layer can discharge the static electricity from a display region. For example, a conductive sealant is connected with a zero potential line of an array substrate, and finally the static electricity on the color filter substrate is led to the zero potential line through the conductive layer, so that the static electricity is discharged from the display region, thereby improving the antistatic capability of the display device and ensuring the display quality.

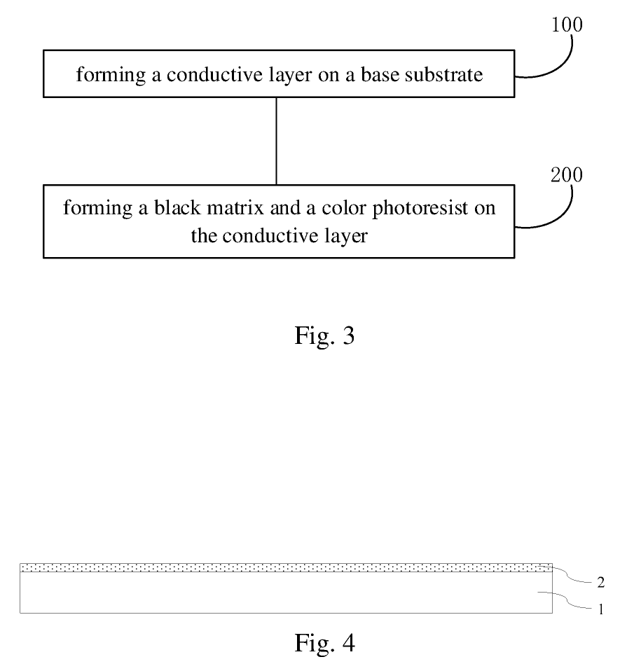

FIG. 3 illustrates a flow chat of a manufacturing method of a color filter substrate provided by an embodiment of the present disclosure. The method includes the following steps:

Step 100, forming a conductive layer on a base substrate.

In the step, the method of forming the conductive layer 2 may be sputtering or thermal evaporation.

A material of the conductive layer 2 can be a graphene layer or an indium tin oxide (ITO) film with thickness of 1˜10 nm. On the basis of ensuring the conductivity, the thinner the layer, the better. The graphene has good electrical conductivity, with a resistivity of 1×10⁻⁸ Ω·m which is less than that of copper and silver; the transparency of graphene is good, the transmittance of a single or multi-layer graphene layer is extremely high. In the present embodiment, the graphene is selected as the conductive layer. Certainly, the conductive layer can also be selected from other conductive materials with good transmittance.

After the step 100, a formed structure is illustrated in FIG. 4.

Step 200, forming a black matrix and a color photoresist on the conductive layer.

Both the black matrix and the color photoresist have electrical conductivity, and the black matrix and the color photoresist partially cover the conductive layer. A portion of the conductive layer 2 is exposed by the black matrix 3 and the color photoresist 4.

In order to make the black matrix 3 have electrical conductivity, the black matrix 3 can be selected from a metal material or a resin material doped with nano conductive particles.

In order to make the color photoresist 4 have electrical conductivity, the color photoresist can adopt a resin material doped with nano conductive particles.

In order to make the abovementioned resin material doped with nano conductive particles have good electrical conductivity and optical transparency, it is required that a dispersion structure of the nano conductive particles in the resin matrix is less than a visible light wavelength range. For example, a maximum particle size of the nano conductive particles is less than 390 nm.

The resin material doped with nano conductive particles in the present embodiment can be made of a conductive medium, film-forming resin, photosensitizer, solvent and additive. In order to ensure good electrical conductivity, the resistivity of the conductive medium is less than 1×10⁻⁷ Ω·m. The conductive medium can be conductive metal particles, conductive alloy particles, and novel conductive materials such as graphene. Graphene has many excellent properties, such as ultra-high theoretical specific surface area (2630 m²/g), outstanding thermal conductivity (500 W/m·K), high-strength (130 GPa), high modulus (1060 GPa), and electro mobility (15000 cm2/(V·s)) which is 100 times higher than silicon at room temperature, and conductivity of 7200 S/cm and so on. Furthermore, as described above, graphene has outstanding electrical conductivity and electron conductivity, a conductive polymer material with high conductivity, low cost and permanent conductivity can be obtained by introducing a small amount of graphene into the polymer. Therefore, in the present embodiment, graphene is selected as the conductive medium. Furthermore, the abovementioned film-forming resin is thermoplastic resin, and the photosensitizer is a derivative of aromatic ketone or a derivative of benzoin ether.

In the step, the black matrix and the color photoresist are formed on the conductive layer by a patterning process. For example, the patterning process includes photoresist coating, exposure, development, etching, photoresist stripping and so on. Specific steps can refer the steps of forming the black matrix and color photoresist in the prior art, the embodiments of the present disclosure are not described herein.

After the step 200, the formed structure refers to FIG. 1.

Embodiments of the present disclosure include the following advantages: the conductive layer being formed on the base substrate of the color filter substrate, and the black matrix and the color photoresist having conductivity being formed on the conductive layer to facilitate static electricity accumulating on the black matrix and the color photoresist to be quickly discharged to the conductive layer. The black matrix and the color photoresist partially cover the conductive layer, and the exposed conductive layer can discharge the static electricity from a display region. For example, a conductive sealant is connected with a zero potential line of an array substrate, and finally the static electricity on the color filter substrate is led to the zero potential line through the conductive layer, so that the static electricity is discharged from the display region, thereby improving the antistatic capability of the display device and ensuring the display quality.

Embodiments of the present specification are described in a progressive manner, each embodiment focuses on differences from other embodiments, and the same or similar parts between the embodiments can be referred to each other. For a system embodiment, because it is basically similar to the method embodiment, the description is relatively simple, and the relevant parts can be referred to the description of the method embodiment.

Although examples of embodiments of the present disclosure have been described, those skilled in the art can make additional changes and modifications to the embodiments once the basic inventive concept is known. Therefore, the claims are intended to be explained as including the examples and all changes and modifications falling within the scope of the embodiments.

Finally, it should be noted that, in the present disclosure, relationship terms such as first and second are used merely to distinguish one entity or operation from another entity or operation, and do not necessarily require or imply any such actual relationship or order between the entities or operations. Furthermore, the terms “comprise,” “include” or any other variant thereof are intended to encompass a non-exclusive inclusion, thus, a process, method, article or terminal device including a series of elements includes not only those elements but also other elements not explicitly listed, or elements inherent to such a processes, method, article or terminal device. Without further limitation, an element defined by the phrase “comprising a . . . ” does not exclude the presence of additional identical elements in a process, method, article, or terminal device that includes the element.

The foregoing is only the embodiments of the present disclosure and not intended to limit the scope of protection of the present disclosure, alternations or replacements which can be easily envisaged by any skilled person being familiar with the present technical field shall fall into the protection scope of the present disclosure. Thus, the protection scope of the present disclosure should be based on the protection scope of the claims.

1. A color filter substrate, comprising:
a base substrate;
a conductive layer on the base substrate; and
a color photoresist on a side of the conductive layer away from the base substrate, wherein the color photoresist is electrically conductive and electrically connected with the conductive layer.

2. The color filter substrate according to claim 1, wherein the color photoresist is in direct contact with the conductive layer.

3. The color filter substrate according to claim 1, further comprising: a conductive black matrix on the side of the conductive layer away from the base substrate, wherein the black matrix is in direct contact with the conductive layer.

4. The color filter substrate according to claim 3, wherein a portion of the conductive layer is exposed by the black matrix and the color photoresist.

5. The color filter substrate according to claim 1, wherein the conductive layer is a graphene layer or an indium tin oxide film.

6. The color filter substrate according to claim 1, wherein the conductive layer has a thickness of 1˜10 nm.

7. The color filter substrate according to claim 3, wherein a material of the black matrix is a metal material or a resin material doped with nano conductive particles.

8. The color filter substrate according to claim 1, wherein a material of the color photoresist is a resin material doped with nano conductive particles.

9. The color filter substrate according to claim 8, wherein the resin material comprises film-forming resin, photosensitizer, solvent and additive.

10. The color filter substrate according to claim 8, wherein a resistivity of the conductive particles is less than 1×10⁻⁷ Ω·m.

11. The color filter substrate according to claim 1, wherein the conductive layer is transparent.

12. The color filter substrate according to claim 1, wherein the conductive layer is configured to be grounded.

13. A display device, comprising the color filter substrate according to claim 1, and a counter substrate, wherein the color filter substrate is opposite to the counter substrate.

14. The display device according to claim 13, further comprising: a sealant between the color filter substrate and the counter substrate, wherein the sealant is provided with a conductive member therein, an end of the conductive member is electrically connected to the conductive layer of the color filter substrate, and another end of the conductive member is electrically connected to a zero potential line on the counter substrate.

15. A manufacturing method for a color filter substrate, comprising:
forming a conductive layer on a base substrate; and
forming a color photoresist on the conductive layer, wherein the color photoresist is electrically conductive and electrically connected with the conductive layer.
